(19) United States
(12) Patent Application Publication
(10) Pub. No.: US 2025/0146693 A1
(43) Pub. Date: May 8, 2025

(54) METHOD FOR CONTROLLING AIR CONDITIONER, AIR CONDITIONER, AND ELECTRONIC DEVICE

(71) Applicants: Xiaomi Technology (Wuhan) Co., Ltd., Wuhan (CN); Beijing Xiaomi Mobile Software Co., Ltd., Beijing (CN)

(72) Inventor: Haolin SONG, Wuhan (CN)

(73) Assignees: Xiaomi Technology (Wuhan) Co., Ltd., Wuhan, HB (CN); Beijing Xiaomi Mobile Software Co., Ltd., Beijing (CN)

(21) Appl. No.: 18/934,670

(22) Filed: Nov. 1, 2024

(30) Foreign Application Priority Data
Nov. 2, 2023 (CN) 202311456588.7

(51) Int. Cl. F24F 11/63

(52) U.S. Cl. CPC F24F 11/63

(57) ABSTRACT

A method for controlling an air conditioner. The method includes determining that an operation mode of the air conditioner is a first mode, wherein the first mode is a mode for controlling an operation of the air conditioner based on a preference, and the first mode is provided with an associated first control, the first control being configured to determine whether to enable a target sub mode of the first mode; and determining that the target sub mode is not enabled, and controlling the operation of the air conditioner according to a customized parameter value corresponding to a first control parameter; determining that the target sub mode is enabled, and controlling the operation of the air conditioner according to a recommended parameter value that corresponds to the first control parameter and is sent by a server.

### CROSS-REFERENCE TO RELATED APPLICATION

The present disclosure is based upon and claims the priority to Chinese Patent Application No. 202311456588.7, filed on Nov. 2, 2023, the contents of which are incorporated herein by reference in their entireties for all purposes.

### TECHNICAL FIELD

This disclosure relates to the field of air conditioning technology, and in particular to a method and device for controlling an air conditioner, an air conditioner, an electronic device, and a storage medium.

### BACKGROUND

With the improvement of people's living standards, air conditioners have been brought into thousands of households, becoming increasingly common. Users' requirements for comfort when using the air conditioners are also increasing.

### SUMMARY

A method for controlling an air conditioner, proposed in the embodiments according to a first aspect of the present disclosure, includes: determining that an operation mode of the air conditioner is a first mode, where the first mode is a mode for controlling an operation of the air conditioner based on a preference, and the first mode is provided with an associated first control, the first control being configured to enable a target sub mode of the first mode; determining that the target sub mode is not enabled, and controlling the operation of the air conditioner according to a customized parameter value corresponding to a first control parameter; determining that the target sub mode is enabled, and controlling the operation of the air conditioner according to a recommended parameter value that corresponds to the first control parameter and is sent by a server.

A method for controlling an air conditioner, proposed in the embodiments according to a second aspect of the present disclosure, includes: determining that an operation mode is in a first mode, where the first mode is a mode for controlling an operation of the air conditioner based on a preference, and the first mode is provided with an associated first control, the first control being configured to enable a target sub mode of the first mode; determining that the target sub mode is not enabled, and operating according to a customized parameter value corresponding to a first control parameter; determining that the target sub mode is enabled, and operating according to a recommended parameter value that corresponds to the first control parameter and is sent by a server.

An electronic device, proposed in the embodiments according to a third aspect of the present disclosure, includes a memory, a processor, and a computer program stored on the memory and executable on the processor. When the processor executes the program, it implements the method for controlling the air conditioner proposed in the embodiments according to the first aspect of the present disclosure, or implements the method for controlling the air conditioner proposed in the embodiments according to the second aspect of the present disclosure.

A non-transitory computer-readable storage medium is proposed in the embodiments according to a fourth aspect of the present disclosure, on which a computer program is stored. When the program is executed by a processor, it implements the method for controlling the air conditioner proposed in the embodiments according to the first aspect of the present disclosure, or implements the method for controlling the air conditioner proposed in the embodiments according to the second aspect of the present disclosure.

A computer program product is proposed in the embodiments according to an eighth aspect of the present disclosure, which, when an instruction in the computer program product is executed by a processor, causes the processor to perform the method for controlling the air conditioner proposed in the embodiments according to the first aspect of the present disclosure, or to perform the method for controlling the air conditioner proposed in the embodiments according to the second aspect of the present disclosure.

The additional aspects and advantages of this disclosure will be partially presented in the following description, some of which will become apparent from the following description, or learned through practice of this disclosure.

### BRIEF DESCRIPTION OF THE DRAWINGS

The above and/or additional aspects and advantages of this disclosure will become apparent and easily understood from the following description of the embodiments in conjunction with the accompanying drawings.

FIG. 1 is a flowchart of a method for controlling an air conditioner proposed in an embodiment of the present disclosure.

FIG. 2A is a schematic diagram of an air conditioner's control interface in an embodiment of the present disclosure.

FIG. 2B is a schematic diagram of the control interface of a recommended preference mode in an embodiment of the present disclosure.

FIG. 3 is a flowchart of a method for controlling an air conditioner proposed in another embodiment of the present disclosure.

FIG. 4 is a schematic diagram of an air conditioner's control interface in another embodiment of the present disclosure.

FIG. 5 is a flowchart of a method for controlling an air conditioner proposed in yet another embodiment of the present disclosure.

FIG. 6 is a flowchart of a method for controlling an air conditioner proposed in still another embodiment of the present disclosure.

FIG. 7 is a schematic diagram of a structure of a device for controlling an air conditioner proposed in an embodiment of the present disclosure.

FIG. 8 is a schematic diagram of a structure of a device for controlling an air conditioner proposed in another embodiment of the present disclosure.

FIG. 9 is a schematic diagram of a structure of an air conditioner proposed in an embodiment of the present disclosure.

FIG. 10 is a block diagram of an exemplary air conditioner suitable for implementing the embodiments of the present disclosure.

### DETAILED DESCRIPTION

Embodiments of the present disclosure are described below, and examples of the embodiments are shown in the accompanying drawings, where the same or similar reference numerals throughout represent the same or similar elements or elements having the same or similar functions. The embodiments described below with reference to the accompanying drawings are exemplary and are only used to explain the present disclosure, and should not be construed as limiting the present disclosure. On the contrary, the embodiments of the present disclosure include all changes, modifications, and equivalents falling within the spirit and scope of the appended claims.

In the related art, operation steps required to control the air conditioner are relatively cumbersome, resulting in the control of the air conditioner is not convenient.

In view of the above, this disclosure proposes a method and device for controlling an air conditioner, an air conditioner, an electronic device, a non-transitory computer-readable storage medium storing a computer instruction, and a computer program product, which can effectively reduce the operation steps required to control the air conditioner and improve the convenience of controlling the air conditioner.

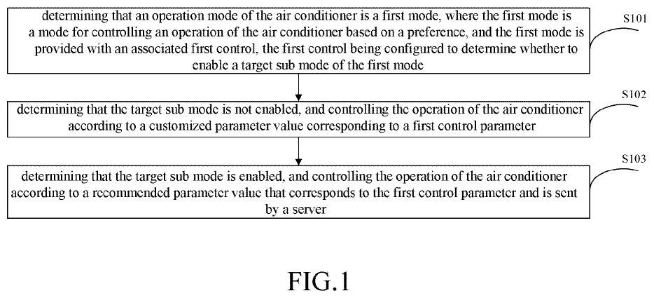

FIG. 1 is a flowchart of a method for controlling an air conditioner proposed in an embodiment of the present disclosure.

This embodiment is illustrated by taking an example of the method for controlling the air conditioner being configured in a device for controlling the air conditioner. The method for controlling the air conditioner in this embodiment may be configured in a device for controlling the air conditioner, and the device may be disposed in a server, or may be disposed in an electronic device, or may be disposed in an air conditioner, and there is no limitation thereon. In this embodiment, the method for controlling the air conditioner is illustrated as being configured in an electronic device. The electronic device is, for example, a hardware device having various operating systems such as a smartphone, a tablet computer, a personal digital assistant, an e-book, and the like.

It should be noted that the executing entity of the embodiment of this disclosure may be, for example, a central processing unit (CPU) in a server, electronic device, or air conditioner in hardware, or may be, for example, a related backend service in a server, electronic device, or air conditioner in software, without limitation.

As shown in FIG. 1, the method for controlling the air conditioner includes the following steps.

S101, determining that an operation mode of the air conditioner is a first mode, where the first mode is a mode for controlling an operation of the air conditioner based on a preference, and the first mode is provided with an associated first control, the first control being configured to determine whether to enable a target sub mode of the first mode.

The first mode refers to a mode for controlling an operation of the air conditioner based on a preference. In some embodiments, when the air conditioner is in the first mode, it can support that the operation of the air conditioner is controlled based on user preferences. The first mode is, for example, a preference mode. An interface can be configured in the electronic device, on which an enabling control of the first mode is set. If the user's command for enabling the first mode is detected based on the control, the air conditioner can be controlled to enter the first mode.

In the embodiment of the present disclosure, when the air conditioner is controlled to enter the first mode, it can also support personalized control of the target sub mode of the first mode. The target sub mode can support the selection of customized preference mode or recommended preference mode. If the target sub mode is enabled, it means that the recommended preference mode is selected. In the recommended preference mode, the air conditioner can be controlled based on the data issued by the server. If the target sub mode is not enabled, it means that the customized preference mode is selected. In the customized preference mode, the air conditioner can be controlled based on the data from user-customized settings.

In the embodiment of the disclosure, the control associated with the first mode can be configured, which can be called the “first control”. The first control can support the determination of whether or not to enable the target sub mode of the first mode. For example, when the first mode is enabled, an interface where the first control is configured can be entered. The first control may be a switch control. If the first control is turned on, it means that the target sub mode is enabled and the recommended preference mode is selected. If the first control is not turned on, it means that the target sub mode is not enabled and the customized preference mode is selected.

In some embodiments, the target sub mode can also be referred to as the recommended preference mode.

S102, determining that the target sub mode is not enabled, and controlling the operation of the air conditioner according to a customized parameter value corresponding to a first control parameter.

In some embodiments, if it is determined that the target sub mode of the first mode is not enabled, the operation of the air conditioner can be controlled according to the customized parameter value corresponding to the first control parameter. The customized parameter value can be pre-customized according to the user's personalized needs. The first control parameter can be, for example, a mode, wind speed, sweeping wind, fixed setting, wind sensation, fresh air, fresh air speed, temperature curve, etc. The customized parameter value refers to a parameter value obtained by customizing the first control parameter.

In some embodiments, if it is determined that the target sub mode is not enabled, the customized parameter value that corresponds to the first control parameter and customized by the user can be acquired, and the operation of the air conditioner can be controlled according to the customized parameter value corresponding to the first control parameter.

S103, determining that the target sub mode is enabled, and controlling the operation of the air conditioner according to a recommended parameter value that corresponds to the first control parameter and is sent by a server.

In some embodiments, if it is determined that the target sub mode of the first mode is enabled, it means that the recommended preference mode is selected, and the air conditioner can be controlled based on the data issued by the server. For example, the recommended parameter value that corresponds to the first control parameter and is sent by the server can be received first, and then the operation of the air conditioner can be controlled based on the recommended parameter value.

In some embodiments, the recommended parameter value corresponding to the first control parameter may be pre received and cached locally, or may be dynamically issued by the server, such as being issued in real-time by the server or dynamically issued by the server according to the issuance cycle, without limitation.

In some embodiments, in performing the step of acquiring the recommended parameter value that corresponds to the first control parameter and is sent by the server, it may be to receive the recommended parameter value corresponding to the first control parameter sent by the server, or to acquire the recommended parameter value corresponding to the first control parameter from a local cache, where the recommended parameter value is pre-pushed to the local by the server. Thus, the flexibility of obtaining the recommended parameter values is effectively improved, and the flexibility and control effect of the control of the air conditioner is effectively enhanced.

In some embodiments, the recommended parameter value may be automatically set by the server for each time period based on the user's historical usage, without limitation.

In this embodiment, it is determined that the operation mode of the air conditioner is the first mode, in which the first mode is the mode for controlling the operation of the air conditioner based on the preference. The first mode is provided the associated first control. The first control is configured to determine whether to enable the target sub mode of the first mode. When it is determined that the target sub mode is not enabled, the operation of the air conditioner is controlled according to the customized parameter value corresponding to the first control parameter. When it is determined that the target sub mode is enabled, the operation of the air conditioner is controlled according to the recommended parameter value that corresponds to the first control parameter and is sent by the server. This can effectively reduce the operation steps required to control the air conditioner, and effectively improve the convenience of controlling the air conditioner.

In some embodiments of the present disclosure, when it is determined that the target sub mode is not enabled, the first control parameter and a second control corresponding to the first control parameter may be provided. The second control is configured to customize a parameter value of the first control parameter. The customized parameter value corresponding to the first control parameter is set via the second control. This effectively supports personalized control of the parameter value of the first control parameter, so that the operational control of the air conditioner can effectively meet personalized needs.

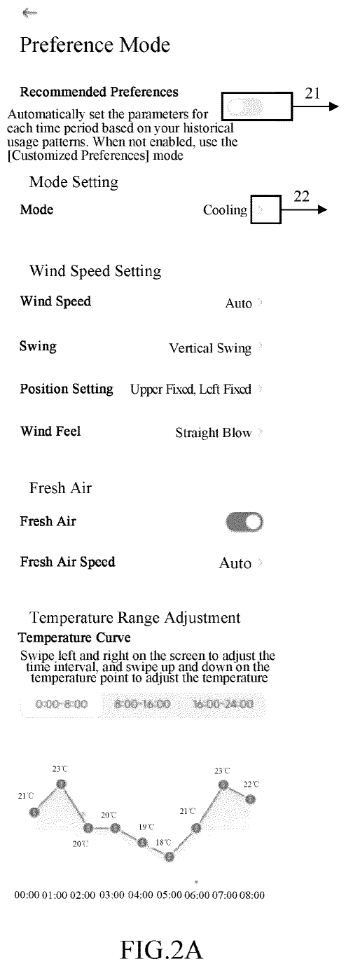

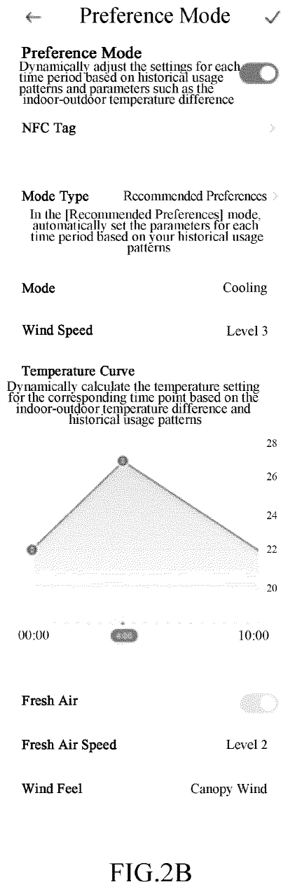

For example, as shown in FIG. 2A, FIG. 2A is a schematic diagram of the air conditioner's control interface in an embodiment of the present disclosure. FIG. 2A shows a situation of entering the first mode and a first control 21 associated with the first mode. When the first control 21 is not enabled, it means that the target sub mode is not enabled, and the customized preference mode is selected. Each first control parameter may correspond to a second control 22 to set a customized parameter value for the corresponding first control parameter. When the first control 21 is enabled, it means that the target sub mode is enabled and the recommended preference mode is selected. In the recommended preference mode, the first control parameter and the second control in FIG. 2A can be grayed out, i.e., not editable. In this case, the operation of the air conditioner is controlled based on the data issued by the server. As shown in FIG. 2B, FIG. 2B is a schematic diagram of a control interface of the recommended preference mode in the embodiment of this disclosure. After triggering the first control 21 in FIG. 2A to enable the target sub mode, the interface shown in FIG. 2A can jump or relocate to the interface shown in FIG. 2B to display the recommended parameter values to the user.

The embodiments of this disclosure provide two methods for setting the customized parameter value of the first control parameter based on the second control, in order to improve the convenience and flexibility of customizing the first control parameter, and facilitate users to quickly customize and control the first control parameter.

In some embodiments, a plurality of candidate parameter values corresponding to the first control parameter may be displayed in response to the second control being triggered, the selected candidate parameter value may be determined from the plurality of candidate parameter values, and the selected candidate parameter value serves as the customized parameter value corresponding to the first control parameter.

For example, when the second control 22, as shown in FIG. 2A and illustrated above, is triggered (e.g. clicked), a pull-down list can be displayed. The pull-down list displays a plurality of candidate parameter values. If a candidate parameter value is selected, it can be used as the selected candidate parameter value. Alternatively, the plurality of candidate parameter values can be displayed in the form of a pop-up window. Alternatively, the interface shown in FIG. 2A can be used to enter the next-level interface, where multiple selectable candidate parameter values can be customized by the user.

In other embodiments, the customized parameter value can be directly received and used as the customized parameter value corresponding to the first control parameter. For example, the second control can also be configured as a parameter value receiving box. By receiving the customized parameter value input by the user based on the parameter value receiving box, the received customized parameter value can be used as the customized parameter value corresponding to the first control parameter.

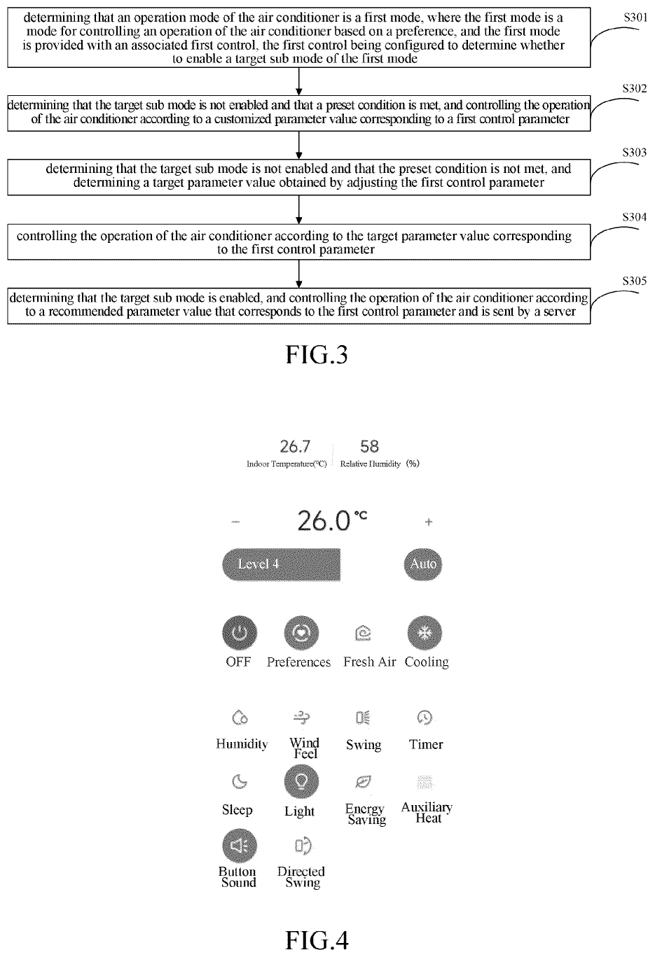

FIG. 3 is a flowchart of a method for controlling an air conditioner proposed in another embodiment of the present disclosure.

As shown in FIG. 3, the method for controlling the air conditioner includes the following steps.

S301, determining that an operation mode of the air conditioner is a first mode, where the first mode is a mode for controlling an operation of the air conditioner based on a preference, and the first mode is provided with an associated first control, the first control being configured to determine whether to enable a target sub mode of the first mode.

The description and explanation of S301 can be specifically referred to in the above embodiment, and will not be repeated here.

S302, determining that the target sub mode is not enabled and that a preset condition is met, and controlling the operation of the air conditioner according to a customized parameter value corresponding to a first control parameter.

In this embodiment, in order to enhance the intelligence level of the control of the air conditioner, it is also possible to deeply recognize the user's control intention, and to detect and determine whether the user has a need for other adjustments to the first control parameter when it is determined that the target sub mode is not enabled. If there is a need for other adjustments, the strategy for the control of the air conditioner can be further analyzed intelligently.

In this embodiment, the preset condition may include: determining that the first control parameter has not been adjusted; or determining that the first control parameter has been adjusted, where an adjustment time is earlier than a customization time of the customized parameter value.

As shown in FIG. 4, FIG. 4 is a schematic diagram of an air conditioner's control interface in another embodiment of the present disclosure. The control interface shown in FIG. 4 can be, for example, the upper-level interface or the parent interface of the control interface shown in FIG. 2A. The “Preferences” control in FIG. 4 can be used to control the air conditioner to be in the first mode. In this interface, the controls “Wind Feel”, “Wind Speed”, etc. can also be configured. This interface contains elements that overlap with the first control parameter in the interface shown in FIG. 2A. When adjustments to the first control parameter are detected in FIG. 4, the operation of the air conditioner can be controlled by combining the target parameter value adjusted in this interface with the customized parameter value shown in FIG. 2A.

For example, if the user does not readjust the first control parameter in the control interface shown in FIG. 4, it is determined that the preset condition is met. If it is also determined that the target sub mode is not enabled, the operation of the air conditioner is controlled based on the customized parameter value corresponding to the first control parameter. If the user readjusts the first control parameter in the control interface shown in FIG. 4, and the adjustment time is earlier than the customized parameter value's customization time, it can be determined that the preset condition is met. If it is also determined that the target sub mode is not enabled, the operation of the air conditioner is controlled based on the customized parameter value corresponding to the first control parameter.

S303, determining that the target sub mode is not enabled and that the preset condition is not met, and determining a target parameter value obtained by adjusting the first control parameter.

S304, controlling the operation of the air conditioner according to the target parameter value corresponding to the first control parameter.

In some embodiments, if it is determined that the target sub mode is not enabled and that the user has readjusted the first control parameter in the control interface shown in FIG. 4, and the adjustment time is later than the customization time, it indicates that the user's latest personalized control demand is reflected in the control interface shown in FIG. 4. Therefore, the target parameter value obtained by adjusting the first control parameter can be determined.

S305, determining that the target sub mode is enabled, and controlling the operation of the air conditioner according to a recommended parameter value that corresponds to the first control parameter and is sent by a server.

The description and explanation of S305 can be specifically referred to in the above embodiment, and will not be repeated here.

In this embodiment, it is determined that the operation mode of the air conditioner is the first mode, where the first mode is the mode for controlling the operation of the air conditioner based on the preference, and the first mode is provided with the associated first control, the first control being configured to determine whether to enable the target sub mode of the first mode. When it is determined that the target sub mode is not enabled and that the preset condition is met, the operation of the air conditioner is controlled according to the customized parameter value corresponding to the first control parameter. When it is determined that the target sub mode is not enabled and that the preset condition is not met, the target parameter value obtained by adjusting the first control parameter is determined, and the operation of the air conditioner is controlled according to the target parameter value corresponding to the first control parameter. When it is determined that the target sub mode is enabled, the operation of the air conditioner is controlled according to the recommended parameter value corresponding to the first control parameter sent by the server. This can effectively reduce the operation steps required to control the air conditioner, and effectively improve the convenience of controlling the air conditioner. To improve the intelligence level of the control of the air conditioner, it is also possible to deeply recognize the user's control intention, and to detect and determine whether the user has a need for other adjustments to the first control parameter when it is determined that the target sub mode is not enabled. If there is a need for other adjustments, the strategy for the control of the air conditioner can be further analyzed intelligently.

In some embodiments of the present disclosure, in performing the step of controlling the operation of the air conditioner according to the customized parameter value corresponding to the first control parameter, an initial parameter value corresponding to a second control parameter may also be determined, where the second control parameter is different from the first control parameter, and the operation of the air conditioner may be controlled according to the initial parameter value corresponding to the second control parameter and the customized parameter value corresponding to the first control parameter. This can further enhance the convenience and intelligence of the control of the air conditioner.

The second control parameter may be, for example, the control parameter in the upper-level control interface, such as the control parameter in the control interface shown in FIG. 4. Specifically, it may be, for example, a temperature parameter. The second control parameter may be a parameter that is different from the first control parameter, such as being of a different type, or being of the same type but controlled in a different way, without limitation.

For example, if it is detected that the temperature parameter in the control interface shown in FIG. 4 has a corresponding initial parameter value, the operation of the air conditioner can be controlled by combining the temperature parameter with the customized parameter value of the first control parameter in the control interface shown in FIG. 2A.

Of course, in other embodiments, after setting the first control parameter of the preference interface in FIG. 2, the parameter value of the first control parameter of the main interface in FIG. 4 can be synchronized with the parameter value of the first control parameter of the preference interface. If the parameter value of the first control parameter of the main interface is adjusted (except for the operation mode and the second control parameter (such as temperature)), the parameter value of the first control parameter of the preference interface will no longer change according to the parameters issued by the server, and the operation of the air conditioner will be controlled according to the adjusted parameter value of the first control parameter of the main interface and other control parameters of the preference interface.

In the embodiment of the present disclosure, an exit method for the first mode is also provided to enhance the speed and flexibility of the start and stop of the first mode.

In some embodiments, if it is determined that the initial parameter value corresponding to the second control parameter has been adjusted, where the second control parameter is different from the first control parameter, the air conditioner may be controlled to exit the first mode.

For example, in a possible embodiment, the temperature parameter in the control interface shown in FIG. 4 may be related to the temperature curve of the control interface shown in FIG. 2A. For example, the fluctuation range of the temperature curve may be related to the initial setting value of the temperature parameter. If the user adjusts the temperature parameter in the control interface shown in FIG. 4, it can be determined that the user's preferences may have changed. In this case, the air conditioner can be controlled to exit the first mode.

In other embodiments, if it is determined that the operation mode of the air conditioner has been adjusted, the air conditioner is controlled to exit the first mode.

For example, if the user adjusts the operation mode of the air conditioner to other modes, such as sleep mode and energy saving mode, the air conditioner can be controlled to exit the first mode.

FIG. 5 is a flowchart of a method for controlling an air conditioner proposed yet in another embodiment of the present disclosure.

As shown in FIG. 5, the method for controlling the air conditioner includes the following steps.

S501, determining that an operation mode of the air conditioner is a first mode, where the first mode is a mode for controlling an operation of the air conditioner based on a preference, and the first mode is provided with an associated first control, the first control being configured to determine whether to enable a target sub mode of the first mode.

The description and explanation of S501 can be specifically referred to in the above embodiments, and will not be repeated here.

S502, determining that the target sub mode is not enabled, and controlling the operation of the air conditioner according to a customized parameter value corresponding to a first control parameter.

S503, determining that the target sub mode is enabled, and controlling the operation of the air conditioner according to a recommended parameter value that corresponds to the first control parameter and is sent by a server.

The description and explanation of S501-S503 can be specifically referred to in the above embodiments, and will not be repeated here.

S504, upon detecting a trigger to set the air conditioner to an off state, recording a current operation mode of the air conditioner.

For example, if the “OFF” control in the control interface shown in FIG. 4 is detected to be triggered, it can be determined that the trigger sets the air conditioner to the off state. Consequently, the current operation mode of the air conditioner can be recorded, e.g., whether the first mode is enabled this time and whether the target sub mode of the first mode is enabled can be recorded.

S505, upon detecting a trigger to set the air conditioner from the off state to an on state, setting the operation mode of the air conditioner according to the recorded operation mode.

In some embodiments, if a trigger is detected to set the air conditioner from the off state to the on state again, the operation mode of the air conditioner is set according to the recorded operating mode. For example, when a restart is detected, the operation mode after this startup can be set directly based on the operation mode from the previous startup.

In this embodiment, it is determined that the operation mode of the air conditioner is the first mode, where the first mode is the mode for controlling the operation of the air conditioner based on the preference, and the first mode is provided with the associated first control, the first control being configured to determine whether to enable the target sub mode of the first mode. When it is determined that the target sub mode is not enabled, the operation of the air conditioner is controlled according to a customized parameter value corresponding to a first control parameter. When it is determined that the target sub mode is enabled, the operation of the air conditioner is controlled according to a recommended parameter value that corresponds to the first control parameter and is sent by a server. This can effectively reduce the operation steps required to control the air conditioner, and effectively improve the convenience of controlling the air conditioner. Upon detecting the trigger to set the air conditioner to the off state, the operation mode of the air conditioner this time is recorded, and upon detecting the trigger to set the air conditioner from the off state to the on state again, the operation mode of the air conditioner is set according to the operation mode recorded this time. This can enhance the convenience and flexibility of setting the air conditioner's operation mode to a greater extent.

In the embodiments of the present disclosure, in order to realize the linkage control of the startup and operation mode to quickly and conveniently control the operation mode of the air conditioner, it is also possible to determine that the air conditioner is in the off state and that a trigger is detected to set the operation mode of the air conditioner to the first mode, to control the air conditioner to switch from the off state to the on state, and to set the operation mode of the air conditioner to the first mode.

For example, in a case where the air conditioner is in the off state, if a trigger is detected in the control interface as shown in FIG. 4 to set the operation mode of the air conditioner to the first mode, the air conditioner can be controlled to start up simultaneously, and the operation mode of the air conditioner can be set to the first mode at the same time.

In the embodiments of the present disclosure, the customized parameter value or recommended parameter value include: a temperature parameter value corresponding to each preset time. Based on multiple temperature parameter values, the operation of the air conditioner can be controlled. In addition, a buzzer state of the air conditioner can be controlled to an off state, and/or a display screen state of the air conditioner can be controlled to a screen-off state. Thus, any impact on the user can be avoided and the user experience can be improved.

For example, customized parameter values can include multiple temperature parameter values, with different temperature parameter values corresponding to different control times. It is possible to detect whether the current time reaches a control time. If the current time reaches the control time, the operation of the air conditioner can controlled based on the temperature parameter value corresponding to that control time.

For example, recommended parameter values can include multiple temperature parameter values, with different temperature parameter values corresponding to different control times. It is possible to detect whether the current time reaches a control time. If the current time reaches the control time, the operation of the air conditioner can be controlled based on the temperature parameter value corresponding to that control time.

For example, if the air conditioner is timed to be controlled based on multiple temperature parameter values, it is also possible to avoid triggering the buzzer or display screen state at each control time, which may affect the user. For example, the buzzer state of the air conditioner can be controlled to the off state, and/or the display screen state of the air conditioner can be controlled to the screen-off state.

In the embodiments of the present disclosure, if it is determined that the buzzer state has been set to a first target state, the buzzer state of the air conditioner is controlled to be in the first target state. The user's personalized settings are detected, so that the control of the state of the buzzer can effectively meet the user's personalized use requirements. For example, the user may personalize the state of the buzzer in the interface as shown in FIG. 4. The state of the buzzer set by the user may be referred to as a first target state. If it is detected that the user has set the buzzer state as the first target state, the buzzer state of the air conditioner may be controlled to be in the first target state. The first target state is, for example, a buzzer or a mute.

In the embodiments of the present disclosure, if it is determined that the display screen state has been set to a second target state, the display screen state of the air conditioner is controlled to be in the second target state. The user's personalized settings are detected, so that the control of the state of the display screen can effectively meet the user's personalized use requirements. For example, users can personalize the state of the display screen in the interface shown in FIG. 4. The state of the display screen set by the user can be referred to as the second target state. If it is detected that the user has set the display screen state as the second target state, the display screen state of the air conditioner can be controlled to be in the second target state. The second target state is, for example, a screen-off state or the screen-on state.

In the embodiments of the present disclosure, the user can control the switch of the preference mode (an optional example of the first mode) to enter the preference mode, and carry out custom settings (wind speed, fresh air, temperature, etc., indicated by an arrow beside the settings). If the recommended preference mode (an optional example of the target sub mode) is turned on, the custom setting field will become unsettable, and the data issued by the server will be obtained to display the current control parameters of the air conditioner. The control parameters will automatically change according to the server's preference mode parameters and be displayed to the user.

In the embodiments of the present disclosure, in the customized preference mode (an optional example of not enabling the target sub mode), the parameter value adjusted for the first control parameter in the main interface, can be different from the parameter value of the first control parameter adjusted in the interface of the preference mode, and the air conditioner is controlled with the latest adjustment.

In the embodiments of the present disclosure, in the recommended preference mode, the operation of the air conditioner can be controlled based on the data issued by the server.

In the embodiments of the present disclosure, the user can control the switch of the preference mode to enter the preference mode, and choose to run the air conditioner with customized preferences or recommended preferences. The customized preferences can be realized by customized settings (wind speed, fresh air, temperature, etc., indicated by arrows beside the settings). In the recommended preference mode, the custom setting fields become unsettable, data is obtained from the server, the current control parameters of the air conditioner are displayed, and the control parameters automatically change according to the server's preference mode parameters and are displayed to the user.

In the embodiments of the present disclosure, during the operation of the customized preferences, when the operation mode is adjusted and the temperature is set in the main interface, the preference mode exits automatically; and when other parameters such as wind speed, fresh air, and air guide control are controlled in the main interface, the preference mode does not exit, and in this case, the wind speed on the main interface can be different from the wind speed set internally in the preference mode.

In the embodiments of the present disclosure, when the air conditioner is turned off and the preference mode is enabled on the main interface, the air conditioner can be controlled to turn on and operate in the preference mode.

In the embodiments of the present disclosure, during the operation of the preference mode, when the set temperature is dispatched at the top of the hour, the air conditioner's buzzer will be turned off. When the user operates autonomously, the buzzer will function according to the user's settings. After the preference mode is turned off, the buzzer will continue to operate based on the user's settings. Similarly, during the operation of the preference mode, when the set temperature is dispatched at the top of the hour, the wired controller's screen will not brighten. When the user operates autonomously, the wired controller will function according to the user's settings. After the preference mode is turned off, the wired controller will continue to operate based on the user's settings.

In the embodiments of the present disclosure, sleep mode, energy-saving mode, and preference mode are mutually exclusive, and the customized sleep and preference modes are mutually exclusive. When the user initiates self-cleaning, the air conditioner will immediately shut down and perform the self-cleaning process, and operations via remote control or wired controller will automatically exits the preference mode.

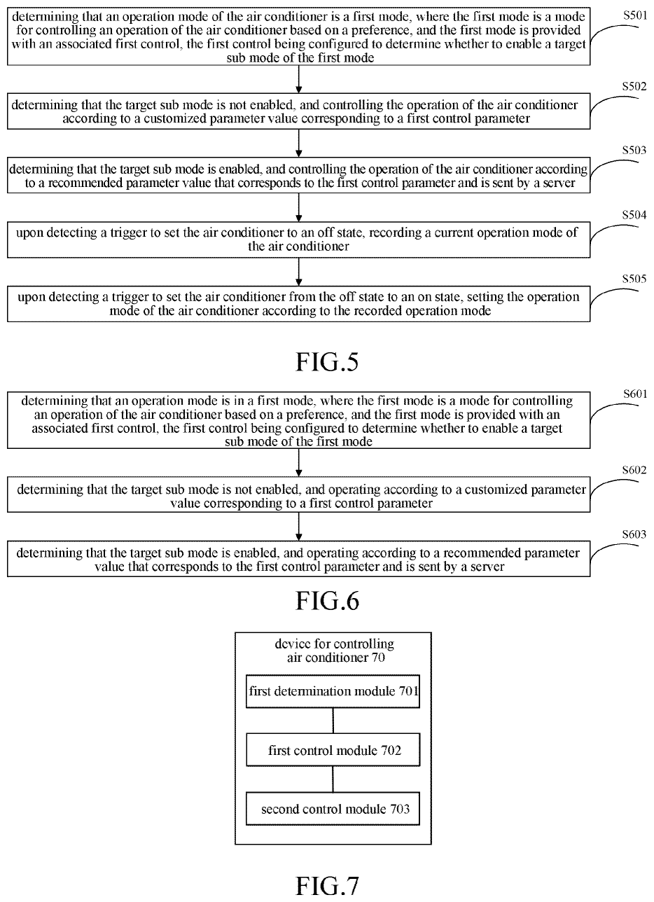

FIG. 6 is a flowchart of a method for controlling an air conditioner proposed in still another embodiment of the present disclosure.

As shown in FIG. 6, the executing entity of this embodiment can be an air conditioner, which can interact with electronic devices and respond to control instructions from the electronic devices, as well as perform corresponding operations. The method for controlling the air conditioner includes the following steps.

S601, determining that an operation mode is in a first mode, where the first mode is a mode for controlling an operation of the air conditioner based on a preference, and the first mode is provided with an associated first control, the first control being configured to determine whether to enable a target sub mode of the first mode.

S602, determining that the target sub mode is not enabled, and operating according to a customized parameter value corresponding to a first control parameter.

S603, determining that the target sub mode is enabled, and operating according to a recommended parameter value that corresponds to the first control parameter and is sent by a server.

The description and explanation of the same or corresponding terms and method steps as in the above embodiments can be specifically referred to in the above embodiments, and will not be repeated here.

In some embodiments of the present disclosure, operating according to the customized parameter value corresponding to the first control parameter includes:
determining an initial parameter value corresponding to a second control parameter, where the second control parameter is different from the first control parameter; and
operating according to the initial parameter value corresponding to the second control parameter and the customized parameter value corresponding to the first control parameter.

In some embodiments of the present disclosure, the method further includes: determining that an initial parameter value corresponding to a second control parameter has been adjusted, where the second control parameter is different from the first control parameter; and exiting the first mode.

In some embodiments of the present disclosure, the method further includes: determining that the operation mode has been adjusted; and exiting the first mode.

In this embodiment, it is determined that the operation mode is in the first mode, where the first mode is the mode for controlling the operation of the air conditioner based on the preference, and the first mode is provided with an associated first control, the first control being configured to determine whether to enable a target sub mode of the first mode. When it is determined that the target sub mode is not enabled, the air conditioner operates based on the customized parameter value corresponding to the first control parameter. When it is determined that the target sub mode is enabled, the air conditioner operates according to the recommended parameter value that corresponds to the first control parameter and is sent by the server. This can effectively reduce the operation steps required to control the air conditioner, and effectively improve the convenience of controlling the air conditioner.

FIG. 7 is a schematic diagram of a structure of a device for controlling an air conditioner proposed in an embodiment of the present disclosure.

As shown in FIG. 7, the device 70 for controlling the air conditioner includes:
a first determination module 701 configured to determine that an operation mode of the air conditioner is a first mode, wherein the first mode is a mode for controlling an operation of the air conditioner based on a preference, and the first mode is provided with an associated first control, the first control being configured to determine whether to enable a target sub mode of the first mode;
a first control module 702 configured to determine that the target sub mode is not enabled, and to control the operation of the air conditioner according to a customized parameter value corresponding to a first control parameter; and
a second control module 703 configured to determine that the target sub mode is enabled, and to control the operation of the air conditioner according to a recommended parameter value that corresponds to the first control parameter and is sent by a server.

It should be noted that the above explanation of the method for controlling the air conditioner also applies to the device for controlling the air conditioner of this embodiment, and will not be repeated here.

In this embodiment, it is determined that the operation mode of the air conditioner is the first mode, in which the first mode is the mode for controlling the operation of the air conditioner based on the preference. The first mode is provided the associated first control. The first control is configured to determine whether to enable the target sub mode of the first mode. When it is determined that the target sub mode is not enabled, the operation of the air conditioner is controlled according to the customized parameter value corresponding to the first control parameter. When it is determined that the target sub mode is enabled, the operation of the air conditioner is controlled according to the recommended parameter value that corresponds to the first control parameter and is sent by the server. This can effectively reduce the operation steps required to control the air conditioner, and effectively improve the convenience of controlling the air conditioner.

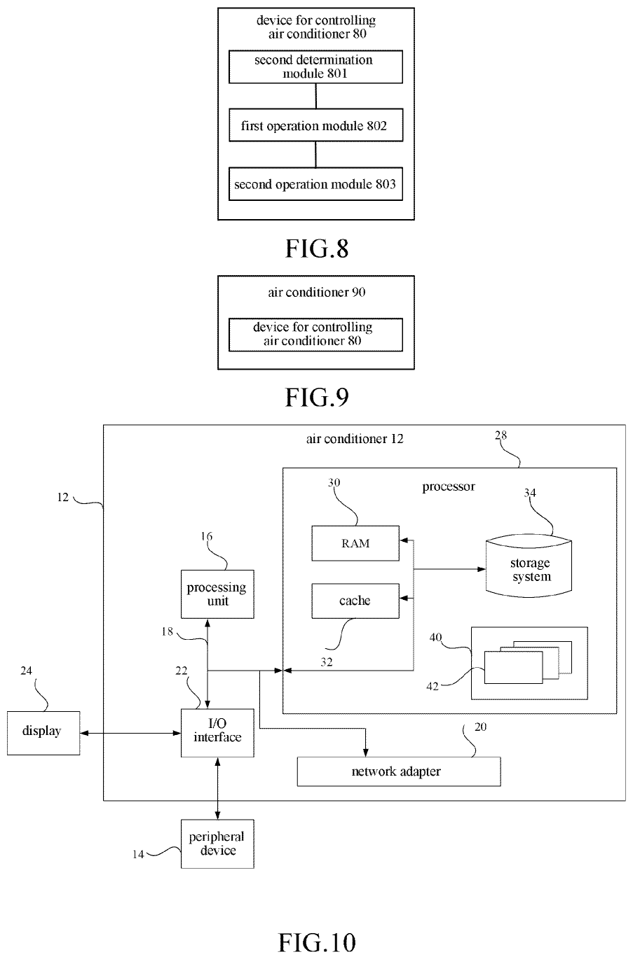

FIG. 8 is a schematic diagram of a structure of a device for controlling an air conditioner proposed in another embodiment of the present disclosure.

As shown in FIG. 8, the device 80 for controlling the air conditioner includes:
a second determination module 801 configured to determine that an operation mode is in a first mode, wherein the first mode is a mode for controlling an operation of the air conditioner based on a preference, and the first mode is provided with an associated first control, the first control being configured to determine whether to enable a target sub mode of the first mode;
a first operation module 802 configured to determine that the target sub mode is not enabled, and to operate according to a customized parameter value corresponding to a first control parameter; and
a second operation module 803 configured to determine that the target sub mode is enabled, and to operate according to a recommended parameter value that corresponds to the first control parameter and is sent by a server.

It should be noted that the above explanation of the method for controlling the air conditioner also applies to the device for controlling the air conditioner of this embodiment, and will not be repeated here.

In this embodiment, it is determined that the operation mode is in the first mode, where the first mode is the mode for controlling the operation of the air conditioner based on the preference, and the first mode is provided with an associated first control, the first control being configured to determine whether to enable a target sub mode of the first mode. When it is determined that the target sub mode is not enabled, the air conditioner operates based on the customized parameter value corresponding to the first control parameter. When it is determined that the target sub mode is enabled, the air conditioner operates according to the recommended parameter value that corresponds to the first control parameter and is sent by the server. This can effectively reduce the operation steps required to control the air conditioner, and effectively improve the convenience of controlling the air conditioner.

FIG. 9 is a schematic diagram of a structure of an air conditioner proposed in an embodiment of the present disclosure.

As shown in FIG. 9, the air conditioner 90 includes:
the device 80 for controlling the air conditioner in the above embodiment.

It should be noted that the above explanation of the method for controlling the air conditioner also applies to the air conditioner of this embodiment, and will not be repeated here.

In this embodiment, it is determined that the operation mode is in the first mode, where the first mode is the mode for controlling the operation of the air conditioner based on the preference, and the first mode is provided with an associated first control, the first control being configured to determine whether to enable a target sub mode of the first mode. When it is determined that the target sub mode is not enabled, the air conditioner operates based on the customized parameter value corresponding to the first control parameter. When it is determined that the target sub mode is enabled, the air conditioner operates according to the recommended parameter value that corresponds to the first control parameter and is sent by the server. This can effectively reduce the operation steps required to control the air conditioner, and effectively improve the convenience of controlling the air conditioner.

FIG. 10 is a block diagram of an exemplary air conditioner suitable for implementing the embodiments of the present disclosure. The air conditioner 12 shown in FIG. 10 is only an example and should not impose any limitations on the functionality and scope of use of the disclosed embodiments.

As shown in FIG. 10, the air conditioner 12 is represented in the form of a general-purpose computing device. The components of air conditioner 12 may include but are not limited to: one or more processors or processing units 16, a memory 28, and a bus 18 connecting different system components (including the memory 28 and the processing unit 16).

The bus 18 represents one or more of several types of bus structures, including memory bus or memory controller, peripheral bus, graphics acceleration port, processor, or local bus using any of multiple bus structures. For example, these architectures include but are not limited to Industry Standard Architecture (ISA) bus, Micro Channel Architecture (MAC) bus, enhanced ISA bus, Video Electronics Standards Association (VESA) local bus, and Peripheral Component Interconnection (PCI) bus.

The air conditioner 12 typically includes multiple computer system-readable media. These media can be any available media accessible to air conditioning unit 12, including volatile and non-volatile media, removable and non-removable media.

The memory 28 may include computer system-readable media in the form of volatile memory, such as Random Access Memory (RAM) 30 and/or cache 32. The air conditioner 12 may further include other removable/non-removable, volatile/non-volatile computer system storage media. As an example only, a storage system 34 can be used to read and write non-removable, non-volatile magnetic media (not shown in FIG. 10, commonly referred to as a “hard disk drive”).

Although not shown in FIG. 10, a disk drive for reading and writing to a removable non-volatile magnetic disk (such as a “floppy disk”) and an optical disk drive for reading and writing to a removable non-volatile optical disk (such as a Compact Disc Read Only Memory (CD-ROM), Digital Video Disc Read Only Memory (DVD-ROM), or other optical media) may be provided. In these cases, each drive can be connected to the bus 18 through one or more data media interfaces. The memory 28 may include at least one program product having a set (e.g., at least one) of program modules configured to perform the functions of the various embodiments disclosed here.

A program/utility 40 with a set (at least one) of program modules 42 may be stored, for example, in the memory 28. Such program modules 42 include, but are not limited to, an operating system, one or more application programs, other program modules, and program data. Each of these examples or some combination thereof may include implementations of a networking environment. The program modules 42 generally perform the functions and/or methods described in the embodiments of this disclosure.

The air conditioner 12 may also communicate with one or more external devices 14 (such as a keyboard, pointing device, display 24, etc.) and may also communicate with one or more devices that enable human interaction with the air conditioner 12 and/or with any device (such as a network card, modem, etc.) that enables the air conditioner 12 to communicate with one or more other computing devices. Such communication may be conducted through an input/output (I/O) interface 22. Furthermore, the air conditioner 12 may communicate with one or more networks (such as a Local Area Network (LAN), Wide Area Network (WAN), and/or public networks like the Internet) through a network adapter 20. As shown in FIG. 10, the network adapter 20 communicates with other modules of the air conditioner 12 through the bus 18. It should be understood that, although not shown in the figures, other hardware and/or software modules may be used in conjunction with the air conditioner 12, including but not limited to microcode, device drivers, redundant processing units, external disk drive arrays, RAID systems, tape drives, and data backup storage systems.

The processing unit 16 performs various functional applications and data processing by running programs stored in the memory 28, such as implementing the methods for controlling the air conditioner mentioned in the aforementioned embodiments.

To achieve the above-mentioned embodiments, this disclosure also proposes a non-transitory computer-readable storage medium having stored thereon a computer program which, when executed by a processor, implements the methods for controlling the air conditioner proposed in the aforementioned embodiments of this disclosure.

To achieve the above-mentioned embodiments, this disclosure also proposes a computer program product which, when the instructions in the computer program product are executed by a processor, performs the methods for controlling the air conditioner proposed in the aforementioned embodiments of this disclosure.

It should be noted that, in the description of this disclosure, terms such as “first”, “second”, etc., are used for descriptive purposes only and are not intended to indicate or imply relative importance. Additionally, in the description of this disclosure, unless otherwise specified, the meaning of “a plurality of” or “multiple” is two or more.

Any process or method description in flowcharts or described herein in other ways can be understood as representing modules, segments, or portions of code that include one or more executable instructions for implementing specific logical functions or processes, and the scope of the preferred embodiments of this disclosure includes additional implementations where functions may be performed in an order other than shown or discussed, including in a basically simultaneous manner or in reverse order according to the functions involved, as would be understood by those skilled in the art to which this disclosure pertains.

It should be understood that various parts of this disclosure can be implemented in hardware, software, firmware, or combinations thereof. In the aforementioned embodiments, multiple steps or methods can be implemented using software or firmware stored in memory and executed by a suitable instruction execution system. For example, if implemented in hardware, as in another embodiment, any one or a combination of the following techniques known in the field can be used: discrete logic circuits with logic gate circuits for implementing logical functions on data signals, application-specific integrated circuits with appropriate combinational logic gate circuits, programmable gate arrays (PGAs), field-programmable gate arrays (FPGAs), etc.

Those of ordinary skill in the art can understand that all or part of the steps of the method for implementing the aforementioned embodiments can be instructed to be completed by related hardware through a program. The program can be stored in a computer-readable storage medium and, when executed, includes one of the steps of the method embodiment or a combination thereof.

Furthermore, in the various embodiments of this disclosure, the functional units can be integrated into one processing module, or each unit can physically exist separately, or two or more units can be integrated into one module. The aforementioned integrated modules can be implemented in the form of hardware or in the form of software functional modules. If the integrated modules are implemented in the form of software functional modules and sold or used as independent products, they can also be stored in a computer-readable storage medium.

The aforementioned storage medium can be read-only memory, magnetic disks, optical disks, etc.

In the description of this specification, the terms “one embodiment”, “some embodiments”, “example”, “specific example”, or “some examples” are intended to mean that the specific features, structures, materials, or characteristics described in conjunction with the embodiment or example are included in at least one embodiment or example of this disclosure. In this specification, the illustrative representations of these terms do not necessarily refer to the same embodiment or example. Moreover, the described specific features, structures, materials, or characteristics may be combined in any suitable manner in any one or more embodiments or examples.

Although the embodiments of this disclosure have been shown and described above, it should be understood that the aforementioned embodiments are exemplary and cannot be construed as limiting this disclosure, and those of ordinary skill in the art can make changes, modifications, substitutions, and variations to the aforementioned embodiments within the scope of this disclosure.

What is claimed is:

1. A method for controlling an air conditioner, comprising:
determining that an operation mode of the air conditioner is a first mode, wherein the first mode is a mode for controlling an operation of the air conditioner based on a preference, and the first mode is provided with an associated first control, the first control being configured to enable a target sub mode of the first mode; and
determining that the target sub mode is not enabled, and controlling the operation of the air conditioner according to a customized parameter value corresponding to a first control parameter;
determining that the target sub mode is enabled, and controlling the operation of the air conditioner according to a recommended parameter value that corresponds to the first control parameter and is sent by a server.

2. The method of claim 1, further comprising:
determining that the target sub mode is not enabled, and providing the first control parameter and a second control corresponding to the first control parameter, wherein the second control is configured to customize a parameter value of the first control parameter; and
setting the customized parameter value corresponding to the first control parameter via the second control.

3. The method of claim 2, wherein setting the customized parameter value corresponding to the first control parameter via the second control comprises:
in response to the second control being triggered, displaying a plurality of candidate parameter values corresponding to the first control parameter; and
determining a selected candidate parameter value from the plurality of candidate parameter values, and determining the selected candidate parameter value as the customized parameter value corresponding to the first control parameter.

4. The method of claim 2, wherein setting the customized parameter value corresponding to the first control parameter via the second control comprises:
receiving a customized parameter value and determining the received customized parameter value as the customized parameter value corresponding to the first control parameter.

5. The method of claim 1, wherein controlling the operation of the air conditioner according to the customized parameter value corresponding to the first control parameter comprises:
determining that a preset condition is met; and
controlling the operation of the air conditioner according to the customized parameter value corresponding to the first control parameter;
wherein the preset condition comprises one of:
the first control parameter has not been adjusted; or
the first control parameter has been adjusted, wherein an adjustment time is earlier than a customization time of the customized parameter value.

6. The method of claim 5, further comprising:
determining that the target sub mode is not enabled and that the preset condition is not met, and determining a target parameter value obtained by adjusting the first control parameter; and
controlling the operation of the air conditioner according to the target parameter value corresponding to the first control parameter.

7. The method of claim 1, wherein controlling the operation of the air conditioner according to the customized parameter value corresponding to the first control parameter comprises:
determining an initial parameter value corresponding to a second control parameter, wherein the second control parameter is different from the second control parameter; and
controlling the operation of the air conditioner according to the initial parameter value corresponding to the second control parameter and the customized parameter value corresponding to the first control parameter.

8. The method of claim 1, further comprising:
determining that an initial parameter value corresponding to a second control parameter has been adjusted, wherein the second control parameter is different from the second control parameter; and
controlling the air conditioner to exit the first mode.

9. The method of claim 1, further comprising:
determining that the operation mode of the air conditioner has been adjusted; and
controlling the air conditioner to exit the first mode.

10. The method of claim 1, further comprising: acquiring the recommended parameter value that corresponds to the first control parameter and is sent by the server by one of:
receiving the recommended parameter value corresponding to the first control parameter sent by the server; or
acquiring the recommended parameter value corresponding to the first control parameter from a local cache, wherein the recommended parameter value is pre-pushed to the local by the server.

11. The method of claim 1, further comprising:
upon detecting a trigger to set the air conditioner to an off state, recording a current operation mode of the air conditioner; and
upon detecting a trigger to set the air conditioner from the off state to an on state, setting the operation mode of the air conditioner according to the recorded operation mode.

12. The method of claim 1, further comprising:
determining that the air conditioner is in an off state and a trigger is detected to set the operation mode of the air conditioner to the first mode;
controlling the air conditioner to switch from the off state to an on state; and
setting the operation mode of the air conditioner to the first mode.

13. The method of claim 1, wherein the customized parameter value or the recommended parameter value comprises: a temperature parameter value corresponding to each preset time; and
wherein controlling the operation of the air conditioner based on the customized parameter value or the recommended parameter value comprises:
controlling the operation of the air conditioner according to a plurality of temperature parameter values; and
controlling a buzzer state of the air conditioner to an off state, and/or, controlling a display screen state of the air conditioner to a screen-off state.

14. The method of claim 13, further comprising at least one of:
determining that the buzzer state has been set to a first target state, and controlling the buzzer state of the air conditioner to the first target state; or
determining that the display screen state has been set to a second target state, and controlling the display screen state of the air conditioner to the second target state.

15. A method for controlling an air conditioner, comprising:
determining that an operation mode is in a first mode, wherein the first mode is a mode for controlling an operation of the air conditioner based on a preference, and the first mode is provided with an associated first control, the first control being configured to enable a target sub mode of the first mode;
determining that the target sub mode is not enabled, and operating according to a customized parameter value corresponding to a first control parameter;
determining that the target sub mode is enabled, and operating according to a recommended parameter value that corresponds to the first control parameter and is sent by a server.

16. The method of claim 15, wherein operating according to the customized parameter value corresponding to the first control parameter comprises:
determining an initial parameter value corresponding to a second control parameter, wherein the second control parameter is different from the first control parameter; and
operating according to the initial parameter value corresponding to the second control parameter and the customized parameter value corresponding to the first control parameter.

17. The method of claim 15, further comprising:
determining that an initial parameter value corresponding to a second control parameter has been adjusted, wherein the second control parameter is different from the first control parameter; and
exiting the first mode.

18. The method of claim 15, further comprising:
determining that the operation mode has been adjusted; and
exiting the first mode.

19. An air conditioner comprising:
at least one processor, and
a memory connected in communication with the at least one processor, wherein
the memory stores an instruction executable by the at least one processor that, when executed by the at least one processor, enables the at least one processor to perform the method according to claim 15.

20. An electronic device, comprising:
at least one processor, and
a memory connected in communication with the at least one processor, wherein the memory stores an instruction executable by the at least one processor that, when executed by the at least one processor, enables the at least one processor to:
determine that an operation mode of the air conditioner is a first mode, wherein the first mode is a mode for controlling an operation of the air conditioner based on a preference, and the first mode is provided with an associated first control, the first control being configured to enable a target sub mode of the first mode; and
determine that the target sub mode is not enabled, and control the operation of the air conditioner according to a customized parameter value corresponding to a first control parameter;
determine that the target sub mode is enabled, and control the operation of the air conditioner according to a recommended parameter value that corresponds to the first control parameter and is sent by a server.
